(19) United States
(12) Patent Application Publication
(10) Pub. No.: US 2007/0195245 A1
(43) Pub. Date: Aug. 23, 2007

(54) APPARATUS FOR MANUFACTURING LIQUID CRYSTAL DISPLAY AND METHOD OF MANUFACTURING THE SAME

(76) Inventor: Baek-Kyun Jeon, Yongin-si (KR)

Correspondence Address: Frank Chau, Esq.;F. CHAU & ASSOCIATES, LLC, 130 Woodbury Road, Woodbury, NY, 11797, US

(21) Appl. No.: 11/610,001

(22) Filed: Dec. 13, 2006

(30) Foreign Application Priority Data
Feb. 23, 2006 (KR) 10-2006-0017629

(51) Int. Cl. G02F 1/1337; G02F 1/03

(52) U.S. Cl. 349/124; 430/20

(57) ABSTRACT

An apparatus for manufacturing a liquid crystal display includes a first roller, a second roller that engages the first roller, a third roller that is disposed substantially opposite to the second roller, wherein the first roller is interposed between the second and third roller and the third roller engages the first roller, a liquid chemical agent supplier that supplies a liquid chemical agent to the first roller, and a printing table on which a substrate contacting the third roller is mounted. The liquid chemical agent includes an aligning agent or spacer ink.

### CROSS-REFERENCE TO RELATED APPLICATION

This application claims priority to Korean Patent Application No. 10-2006-0017629 filed in the Korean Intellectual Property Office on Feb. 23, 2006, the contents of which are incorporated herein by reference in their entirety.

### BACKGROUND OF THE INVENTION

1. Technical Field

The present invention relates to an apparatus for manufacturing a liquid crystal display and a method of manufacturing the same.

2. Discussion of the Related Art

A liquid crystal display includes two display panels on which field generating electrodes and an alignment layer are formed, and a liquid crystal layer that is interposed between the two display panels. In the liquid crystal display, a voltage is applied to the field generating electrodes to generate an electric field and the alignment of liquid crystal molecules of the liquid crystal layer is changed by the electric field. Accordingly, the transmittance of light passing through the liquid crystal layer is controlled.

The alignment layer is formed on the field generating electrodes to determine the initial alignment state of the liquid crystal molecules and the field generating electrodes generate an electric field to change the alignment state of the liquid crystal molecules. The two display panels of the liquid crystal display are formed around edges of the liquid crystal display and are bonded to each other through a sealant that shields liquid crystal materials. In addition, the two display panels are supported by a spacer between the two display panels that maintains a cell gap.

The alignment layer is formed by using a flexo printing apparatus. The flexo printing apparatus includes a plurality of metal rolls, such as an anilox roll and a printing roll, that engage each other, and a printing table on which a rubber plate and a display panel are mounted. The rubber plate adheres to the metal rolls. When the printing table moves, the alignment layer is printed from the rubber plate to the display panel. However, as the size of the display panel increases, the sizes of the metal rolls, the rubber plate, and the printing table increases, which results in increasing the facility cost and space.

According to a method of forming bead spacers that are irregularly dispersed, which is one of the methods for forming the spacers, the bead spacers act as foreign particles that cause the light to leak, thereby deteriorating a contrast ratio (contrast). In addition, some bead spacers move minutely and damage the alignment layer. Further, according to a method of forming column spacers formed in predetermined patterns, a separate photolithography process is required, thereby increasing the production cost. In addition, unlike plastic bead spacers, elastic force is weak in column spacers. As a result, a margin of liquid crystal dropping amount is reduced, thereby causing a defective filling failure or a smear failure where a spacer or a lower film is broken. As a result, a bead spacer printing apparatus for printing bead spacers on predetermined locations of the substrate has been developed. However, according to this method, as the size of the substrate increases, the sizes of the spacer supply roller and the transcribing roller increases.

### SUMMARY OF THE INVENTION

An exemplary embodiment of the present invention provides an apparatus for manufacturing a liquid crystal display including a first roller, a second roller that engages the first roller, a third roller that is disposed substantially opposite to the second roller, wherein the first roller is interposed between the second and third roller and the third roller engages the first roller, a liquid chemical agent supplier that supplies a liquid chemical agent to the first roller, and a printing table on which a substrate contacting the third roller is mounted. The liquid chemical agent includes an aligning agent or spacer ink.

The third roller may rotatably move and transcribe the liquid chemical agent to the substrate.

The first roller may be a liquid chemical agent supply roller that is supplied with the aligning agent, the second roller may be a smoothing roller that smoothes the liquid chemical agent supplied to the liquid chemical agent supply roller, and the third roller may be a printing roller that receives the liquid chemical agent supplied to the liquid chemical agent supply roller and prints the liquid chemical agent onto the substrate.

The first roller and the third roller may rotate in directions opposite each other.

A printing plate may have a printed pattern attached to an outer circumferential surface of the printing roller, and the printed pattern may correspond to an alignment layer pattern to be formed on the substrate, The apparatus for manufacturing a liquid crystal display may further include a waste liquid tray located below the first roller to accommodate a waste liquid chemical agent.

The second roller may rotate in contact with an outer circumferential surface of the first roller and reciprocate in an axial direction.

The first roller may be a spacer supply roller having a surface with a plurality of grooves formed therein that is supplied with the spacer ink and the second roller may be a pressurizing roller that uniformly injects the spacer ink into the grooves of the spacer supply roller, where the spacer ink may be injected into the grooves using a blade in contact with the surface of the spacer supply roller.

The third roller may be a transcribing roller having a surface onto which the spacer ink injected into the grooves of the spacer supply roller is transcribed.

The spacer ink may contain at least one of bead spacers or a hardener, and intervals among the spacer ink that has been transcribed onto the surface of the transcribing roller may be the same as predetermined intervals among the grooves.

An exemplary embodiment of the present invention provides a method of manufacturing a liquid crystal display including supplying a plurality of aligning agent printing rollers that engage one another and an aligning agent supplier that supplies an aligning agent to at least one of the plurality of aligning agent printing rollers, printing an alignment layer on a substrate, substituting the plurality of aligning agent printing rollers and the aligning agent supplier with a plurality of spacer printing rollers engaging one another and a spacer supplier, and printing spacers on the substrate.

The plurality of aligning agent printing rollers may include a liquid chemical agent supply roller supplied with the aligning agent, a smoothing roller that smoothes the liquid chemical agent supplied to the liquid chemical agent supply roller, and a printing roller that receives the liquid chemical agent supplied to the liquid chemical agent supply roller and prints the liquid chemical agent onto the substrate.

The plurality of spacer printing rollers may include a spacer supply roller having a surface with a plurality of grooves formed therein that is supplied with the spacer ink, a pressurizing roller that uniformly injects the spacer ink into the grooves of the spacer supply roller, and a transcribing roller in which the spacer ink is transcribed from the grooves of the spacer supply roller onto the surface of the transcribing roller.

The method of manufacturing a liquid crystal display may further include adhering the spacer ink to the substrate from the transcribing roller.

### BRIEF DESCRIPTION OF THE DRAWINGS

Exemplary embodiments of the present invention can be understood in more detail from the following descriptions taken in conjunction with the attached drawings in which.

FIG. 1 shows an apparatus for manufacturing a liquid crystal display used as a spacer printing apparatus according to an exemplary embodiment of the present invention.

FIG. 2 shows an apparatus for manufacturing a liquid crystal display used as a spacer printing apparatus according to an exemplary embodiment of the present invention.

FIG. 3 shows an enlarged view of spacer ink.

FIG. 4 shows a process of printing an alignment layer by using the alignment layer printing apparatus of FIG. 1.

FIG. 5A shows a process of uniformly injecting spacer ink dripped on a spacer supply roller of the spacer printing apparatus of FIG. 2.

FIG. 5B shows a spacer supply roller in which spacer ink is injected into grooves of a spacer supply roller.

FIG. 6 shows a process of transcribing spacer ink from a spacer supply roller to a transcribing plate and transcribing spacer ink from a transcribing plate to a display panel.

FIG. 7 shows a process of forming a spacer by hardening spacer ink transcribed onto a display panel.

### DETAILED DESCRIPTION OF EXEMPLARY EMBODIMENTS

Exemplary embodiments of the present invention will be described more fully hereinafter with reference to the accompanying drawings. The described embodiments may be modified without departing from the spirit or scope of the present invention. Like reference numerals designate like elements throughout the specification.

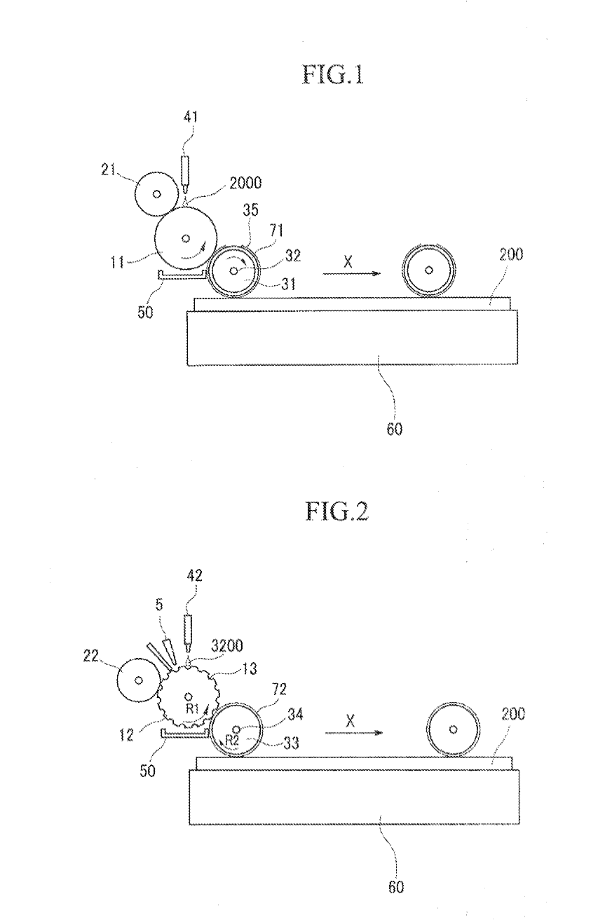

An apparatus for manufacturing a liquid crystal display for alignment layer printing and spacer printing according to exemplary embodiments of the present invention will now be described. FIG. 1 shows an apparatus for manufacturing a liquid crystal display used as an alignment layer printing apparatus according to an exemplary embodiment of the present invention.

As shown in FIG. 1, the apparatus used for alignment layer printing includes first to third rollers 11, 21, and 31, a liquid chemical agent supplier 41, a waste liquid tray 50, and a printing table 60.

The first to third rollers 11, 21, and 31 correspond to a liquid chemical agent supply roller 11 that is located below the liquid chemical agent supplier 41, a smoothing roller 21 that engages the liquid chemical agent supply roller 11, and a printing roller 31 that engages the liquid chemical agent supply roller 11 disposed substantially opposite the smoothing roller 21 with the liquid chemical agent supply roller 11 interposed therebetween, respectively. Furthers an outer circumferential surface of the printing roller 31 comes into contact with a display panel 200 that is mounted on the printing table 60.

The liquid chemical agent supply roller 11 rotates in a rotational direction opposite to a rotational direction of the printing roller 31, and an aligning agent 2000 is supplied to an outer circumferential surface of the liquid chemical agent supply roller 11. The smoothing roller 21 reciprocates in an axial direction in which an outer circumferential surface of the smoothing roller 21 comes into contact with the outer circumferential surface of the liquid chemical agent supply roller 11 and smoothes the aligning agent 2000 on the outer circumferential surface of the liquid chemical agent supply roller 1. Instead of the smoothing roller 21, a rod-shaped smoothing blade (not shown) may be used.

The liquid chemical agent supplier 41 is located above the liquid chemical agent supply roller 11 and drips the aligning agent 2000 onto the outer circumferential surface of the liquid chemical agent supply roller 11. The aligning agent 2000 may be an organic aligning agent, such as a polyimide-based aligning agent, or an organic aligning agent.

The waste liquid tray 50 is disposed below the liquid chemical agent supply roller 11, and accommodates droplets of the aligning agent 2000 dripped from the liquid chemical agent supply roller 11 while the smoothing roller 21 smoothes the aligning agents 2000 on the outer circumferential surface of the liquid chemical agent supply roller 11.

The printing roller 31 is movable in a direction X perpendicular to a shaft 32 of the printing roller 31, and the printing table 60 is fixed on a surface (not shown) with the display panel 200 mounted thereon. A printing plate 71 having a convex printed pattern 35 is attached to the outer circumferential surface of the printing roller 31. The printing plate 71 may be made of synthetic rubber. The synthetic rubber for the printing plate 71 is preferably an ethylene propylene terpolymer (EPDM), and the EPDM contains ethylene, propylene, and non-conjugated diene. The EPDM is a rubber that is superior in ozone resistance, weather resistance, heat resistance, and solvent resistance, for example, and has lower specific gravity than other synthetic rubbers, in which filler or oil is densely filled.

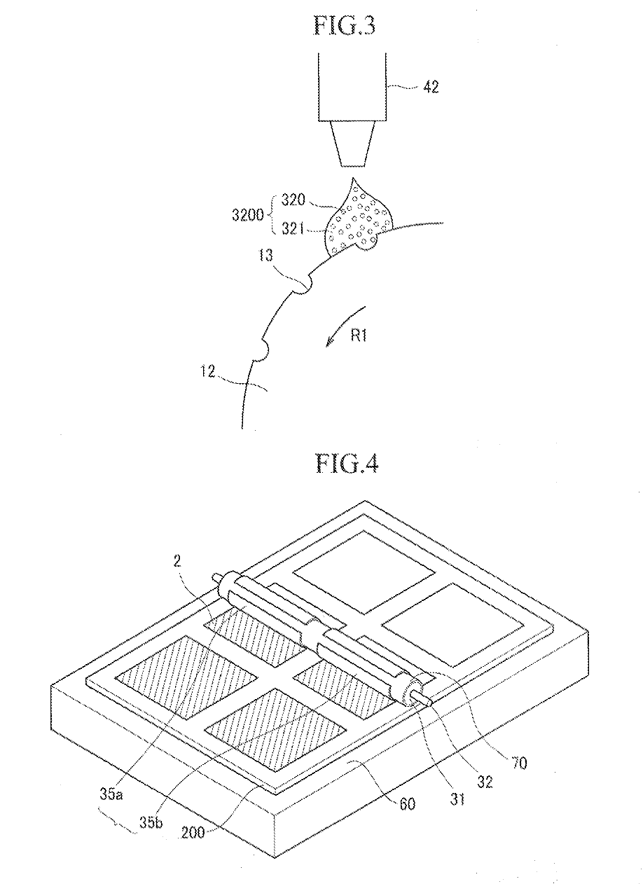

FIG. 2 shows an apparatus for manufacturing a liquid crystal display used as a spacer printing apparatus according to an exemplary embodiment of the present invention, and FIG. 3 shows an enlarged view of spacer ink.

As shown in FIG. 2, the apparatus used for spacer printing includes first to third rollers 12, 22, and 33, a spacer supplier 42, a waste liquid tray 50, and a printing table 60.

The first to third rollers 12, 22, and 33 correspond to a spacer supply roller 12 that is located below the spacer supplier 42, a pressurizing roller 22 that engages the spacer supply roller 12, and a transcribing roller 33 that engages the spacer supply roller 12 disposed substantially opposite the pressurizing roller 22 with the spacer supply roller 12 interposed therebetween, respectively. Further, an outer circumferential surface of the transcribing roller 33 comes into contact with a display panel 200 that is mounted on the printing table 60.

The spacer supply roller 12 rotates in a rotational direction R1 opposite a rotational direction R2 of the transcribing roller 33, and spacer ink 3200 is supplied to an outer circumferential surface of the spacer supply roller 12. The spacer supply roller 12 is made of glass, plastic, or metal material (e.g., stainless steel, SUS), and has formed at predetermined intervals on its outer circumferential surface a plurality of grooves 13, made by forming protrusions and depressions by a photolithography method, a molding method, or a laser machining method.

The spacer supplier 42 is located above the spacer supply roller 12 and drips the spacer ink 3200 onto the outer circumferential surface of the spacer supply roller 12. As shown in FIG. 3, the spacer ink 3200 contains a plurality of bead spacers 320 and a thermal or ultraviolet hardener 321 that hardens the bead spacers 320 on the display panel 200 to adhere the bead spacers 320 to the display panel 200. The bead spacers 320 are made of an organic material, such as an acryl organic compound capable of forming a polymer, Teflon, benzocyclobutene (benzocyclobutene, BCB), cytop, and perfluorocyclobutene (perfluorocyclobutene, PFCB), that has a low dielectric constant.

At least one smoothing blade 5 and the pressurizing roller 22 are sequentially provided after the spacer supplier 42 with respect to the rotational direction R1 of the spacer supply roller 12.

The at least one smoothing blade 5, in contact with the outer circumferential surface of the spacer supply roller 12, injects the spacer ink 3200 dripped onto the outer circumferential surface of the spacer supply roller 12 into the grooves 13 of the spacer supply roller 12, and removes excess spacer ink. In the case of multiple smoothing blades 5, a smoothing blade 5 that injects the spacer ink 3200 into the grooves 13 is disposed in advance of a smoothing blade 5 that removes the excess spacer ink 3200. In this case, the smoothing blade 5 for injecting the spacer ink 3200 into the grooves 13 does not contact the surface of the spacer supply roller 12, and the smoothing blade 5 for removing excess spacer ink 3200 that is not injected into the grooves 13 contacts the surface of the spacer supply roller 12.

The pressurizing roller 22 rotates while its outer circumferential surface engages the outer circumferential surface of the spacer supply roller 12, and pressurizes the spacer ink 3200 injected into the grooves 13 of the outer circumferential surface of the spacer supply roller 12 such that the spacers 320 and the hardener 321 are uniformly distributed in the grooves 13. Accordingly, the transcription and the uniformity of the spacers 320 are improved.

The waste liquid tray 50 is disposed below the spacer supply roller 12, and accommodates droplets of the spacer ink 3200 dripped from the spacer supply roller 12 while the smoothing blades 5 and the pressurizing roller 22 inject the spacer ink 3200 into the grooves 13 of the outer circumferential surface of the spacer supply roller 12 and smooth the spacer ink 3200.

The transcribing roller 33 is movable in a direction X perpendicular to a shaft 34 of the transcribing roller 33, and the printing stand 60 is fixed on a surface (not shown) with the display panel 200 mounted thereon. A transcribing plate 72 is attached to the outer circumferential surface of the transcribing roller 33. The transcribing plate 72 is preferably made of silicone having a superior hydrophilic property, such that the spacer ink 3200 may easily adhere to the transcribing plate 72.

The spacer ink 3200 that has been injected into the grooves 13 of the spacer supply roller 12 is firstly transcribed onto a surface of the transcribing plate 72 of the transcribing roller 33 that comes into contact with the outer circumferential surface of the spacer supply roller 12. The predetermined intervals among the plurality of grooves 13 are about the same as intervals among the spacers 320 that are disposed on the display panel 200, and the rotational direction R2 of the transcribing roller 33 is opposite to the rotational direction R1 of the spacer supply roller 12. Further, when the transcribing roller 33 rotates, the spacer ink 3200 that adheres to the surface of the transcribing plate 72 is transcribed onto the surface of the display panel 200 that comes into contact with the transcribing plate 72 of the transcribing roller 33.

To improve liquid crystal display manufacturing apparatus efficiency, the same basic apparatus may be used for alignment layer printing as for spacer printing by respectively substituting the liquid chemical agent supply roller 11, the smoothing roller 21, the printing roller 31, and the liquid chemical agent supplier 41 of the alignment layer printing apparatus with the spacer supply roller 12, the pressurizing roller 22, the transcribing roller 33, and the spacer supplier 42 of the spacer printing apparatus, as well as other incidental or related items.

A method of manufacturing a liquid crystal display by using an apparatus according to exemplary embodiments of the present invention will now be described.

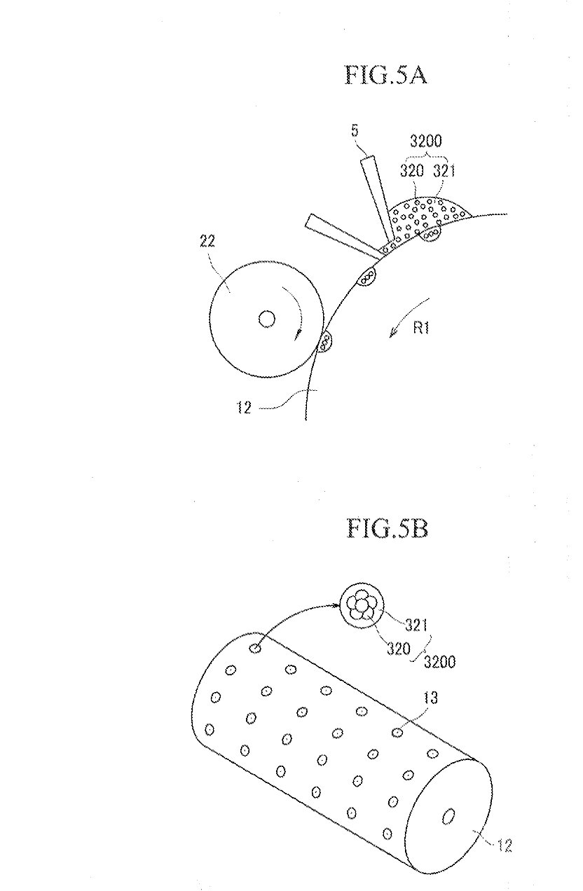

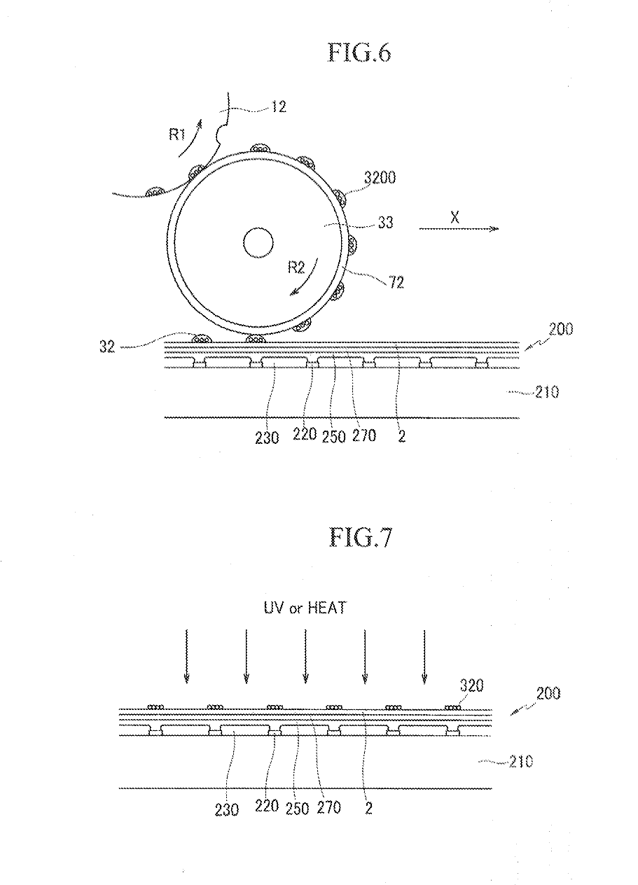

FIG. 4 shows a process of printing an alignment layer by using the alignment layer printing apparatus of FIG. 1. FIG. 5A shows a process of uniformly injecting spacer ink dripped on a spacer supply roller of the spacer printing apparatus of FIG. 2, and FIG. 58 shows a spacer supply roller in which spacer ink is injected into grooves of a spacer supply roller. FIG. 6 shows a process of transcribing spacer ink from a spacer supply roller to a transcribing plate and transcribing spacer ink from a transcribing plate to a display panel, and FIG. 7 shows a process of forming a spacer by hardening spacer ink transcribed onto a display panel.

As shown in FIGS. 1 and 4, an alignment layer 2 is formed by using the apparatus for manufacturing a liquid crystal display as an alignment layer printing apparatus.

First, the liquid chemical agent supplier 41 drips the aligning agent 2000 onto the outer circumferential surface of the liquid chemical agent supply roller 11. Next, the smoothing roller 21 smoothes the aligning agent 2000 on the outer circumferential surface of the liquid chemical agent supply roller 11. Then, the aligning agent 2000 adhered to the liquid chemical agent supply roller 11 is transcribed onto the surface of the printed pattern 35 of the printing roller 31 that comes into contact with the outer circumferential surface of the liquid chemical agent supply roller 11. After that, the aligning agent 2000 adhered to the surface of the printed pattern 35 of the printing roller 31 is transcribed onto the surface of the display panel 200 that comes into contact with the outer circumferential surface of the printing roller 31. Accordingly, the aligning agent 2000 is coated onto the display panel 200 in a pattern equal to the printed pattern 35 of the printing roller 31, and is hardened at a predetermined temperature to form an alignment layer 2.

When the circumference of the printing roller 31, including the rubber plate 70, is smaller than the length of the display panel 200, the printing roller 31 rotates one time or more such that the alignment layer pattern 2 is printed onto the entire region of the display panel 200. In this case, the alignment layer pattern 2 that is printed onto the display panel 200 includes patterns that are repeatedly disposed in a movement direction of the printing roller 31.

Referring to FIG. 4, the alignment layer pattern 2 is disposed in a matrix of two rows by three columns in a movement direction of the printing roller 31 and in an axial direction of the printing roller 31 that is, in a square unit pattern. Two square unit patterns that are adjacent to each other in the movement direction of the printing roller 31 are spaced apart from each other at a predetermined distance, and two square unit patterns that are adjacent to each other in the axial direction of the printing roller 31 are spaced apart at a predetermined distance.

To form the alignment layer pattern, the predetermined pattern 35 that is formed on the printing roller 31 includes two convex portions 35a and 35b with the same size and shape that are disposed in an axial direction of the printing roller 31 and rotates three times. The convex portions 35a and 35b are spaced apart at a predetermined distance.

As shown in FIG. 2, the apparatus for manufacturing a liquid crystal display is used as a spacer printing apparatus to form the spacers 320.

First, as shown in FIG. 3, the spacer ink 3200 is dripped onto the outer circumferential surface of the spacer supply roller 12 by using the spacer supplier 42. The spacer supply roller 12 rotates in a counter-clockwise direction R1.

Next, as shown in FIGS. 5A and 5B, by using the smoothing blades 5, the spacer ink 3200 is injected into the grooves 13 that are formed in the spacer supply roller 12. The plurality of bead spacers 320 form a group and are injected into the grooves 13 together with the hardener 321. The size of each of the spacers 320 that are injected into the grooves 13 is preferably smaller than a diameter of each of the grooves 13. Further, six or seven spacers 320 may be injected into one groove, and the number of spacers 320 that may be injected depends on the size of the predetermined cell gap or the display panel 200.

Then, as shown in FIG. 6, the spacer supply roller 12, still rotating in the counter-clockwise direction R1, engages with the surface of the transcribing plate 72 of the transcribing roller 33, which rotates in a clockwise direction R2. The spacer ink 3200 having been injected into the grooves 13 of the spacer supply roller 12 is transcribed onto the surface of the transcribing plate 72 of the transcribing roller 33. At this time, the intervals among the spacer ink 3200 are the same as the predetermined intervals among the grooves 13, and the spacer ink 3200 adheres to the surface of the transcribing plate 72. After that the spacer ink 3200 adhering to the surface of the transcribing plate 72 is transcribed onto the display panel 200 that comes into contact with the transcribing plate 72 of the transcribing roller 33. As a result, the spacer ink 3200 is disposed on the predetermined locations of the display panel 200 at uniform intervals. Additionally, FIG. 6 illustrates the display panel 200 having a substrate 210 on which a light blocking member 220, a color filter 230, an overcoat 250, a common electrode 270, the alignment layer 2, and the bead spacers 320 are sequentially formed. Thus, the spacer ink 3200 is accurately disposed on a region corresponding to the light blocking member 220.

As shown in FIG. 7, the transcribed spacer 320 and the thermal hardener or the ultraviolet hardener 321 are cured by heat or ultraviolet rays, and are fixedly adhered to the display panel 200.

As such, an alignment layer and spacer printing apparatus are provided in which the aligning agent supply roller 11 is mounted at the time of printing the alignment layer and the spacer supply roller 12 is mounted at the time of printing the spacer.

According to the apparatus for manufacturing a liquid crystal display and the method of manufacturing the same, both the aligning layer and the spacer can be formed by one manufacturing apparatus, and thus the cost and space for the apparatus can be reduced.

While the present invention has been shown and described with reference to exemplary embodiments thereof, it will be understood by those skilled in the art that various changes in form and details may be made therein without departing from the spirit and scope of the present invention as defined by the appended claims.

What is claimed is:

1. An apparatus for manufacturing a liquid crystal display, comprising:
a first roller;
a second roller that engages the first roller;
a third roller that is disposed substantially opposite to the second roller, wherein the first roller is interposed between the second and third roller and the third roller engages the first roller;
a liquid chemical agent supplier that supplies a liquid chemical agent to the first roller; and
a printing table on which a substrate contacting the third roller is mounted,
wherein the liquid chemical agent includes an aligning agent or spacer ink.

2. The apparatus for manufacturing a liquid crystal display of claim 1, wherein the third roller rotatably moves and transcribes the liquid chemical agent onto the substrate.

3. The apparatus for manufacturing a liquid crystal display of claim 2, wherein;
the first roller is a liquid chemical agent supply roller that is supplied with the aligning agent; and
the second roller is a smoothing roller that smoothes the liquid chemical agent supplied to the liquid chemical agent supply roller.

4. The apparatus for manufacturing a liquid crystal display of claim 3 wherein the third roller is a printing roller that receives the liquid chemical agent supplied to the liquid chemical agent supply roller and prints the liquid chemical agent onto the substrate.

5. The apparatus for manufacturing a liquid crystal display of claim 4, wherein the first and third rollers rotate in directions opposite each other.

6. The apparatus for manufacturing a liquid crystal display of claim 5, wherein a printing plate having a printed pattern is attached to an outer circumferential surface of the printing roller.

7. The apparatus for manufacturing a liquid crystal display of claim 6, wherein the printed pattern corresponds to an alignment layer pattern to be formed on the substrate.

8. The apparatus for manufacturing a liquid crystal display of claim 7, further comprising a waste liquid tray located below the first roller to accommodate a waste liquid chemical agent.

9. The apparatus for manufacturing a liquid crystal display of claim 3, wherein the second roller rotates in contact with an outer circumferential surface of the first roller and reciprocates in an axial direction.

10. The apparatus for manufacturing a liquid crystal display of claim 2, wherein the first roller is a spacer supply roller having a surface with a plurality of grooves formed therein that is supplied with the spacer ink.

11. The apparatus for manufacturing a liquid crystal display of claim 10, wherein the second roller is a pressurizing roller that uniformly injects the spacer ink into the grooves of the spacer supply roller.

12. The apparatus for manufacturing a liquid crystal display of claim 11, wherein the spacer ink is injected into the grooves using a blade in contact with the surface of the spacer supply roller.

13. The apparatus for manufacturing a liquid crystal display of claim 12, wherein the third roller is a transcribing roller having a surface onto which the spacer ink injected into the grooves of the spacer supply roller is transcribed.

14. The apparatus for manufacturing a liquid crystal display of claim 13, wherein the spacer ink contains at least one of bead spacers or a hardener.

15. The apparatus for manufacturing a liquid crystal display of claim 14, wherein intervals among the spacer ink that has been transcribed to the surface of the transcribing roller are the same as predetermined intervals among the grooves.

16. A method of manufacturing a liquid crystal display, comprising:
supplying a plurality of aligning agent printing rollers that engage one another and an aligning agent supplier that supplies an aligning agent to at least one of the plurality of aligning agent printing rollers;
printing an alignment layer on a substrate;
substituting the plurality of aligning agent printing rollers and the aligning agent supplier with a plurality of spacer printing rollers engaging one another and a spacer supplier; and
printing spacers on the substrate.

17. The method of manufacturing a liquid crystal display of claim 16, wherein the plurality of aligning agent printing rollers comprise:
a liquid chemical agent supply roller supplied with the aligning agent,
a smoothing roller that smoothes the liquid chemical agent supplied to the liquid chemical agent supply roller; and
a printing roller that receives the liquid chemical agent supplied to the liquid chemical agent supply roller and prints the liquid chemical agent onto the substrate.

18. The method of manufacturing a liquid crystal display of claim 16, wherein the plurality of spacer printing rollers comprise:
a spacer supply roller having a surface with a plurality of grooves formed therein that is supplied with spacer ink.
a pressurizing roller that uniformly injects the spacer ink into the grooves of the spacer supply roller; and
a transcribing roller in which the spacer ink is transcribed from the grooves of the spacer supply roller onto the surface of the transcribing roller.

19. The method of manufacturing a liquid crystal display of claim 18, further comprising adhering the spacer ink to the substrate from the transcribing roller.
